(19) United States
(12) Patent Application Publication
(10) Pub. No.: US 2017/0347301 A1
(43) Pub. Date: Nov. 30, 2017

(54) Virtual Roaming Methods And Apparatus Thereof

(71) Applicant: MediaTek Singapore Pte. Ltd., Singapore (SG)

(72) Inventors: Hasan Ali Stationwala, Indore (IN); Amit Kumar Shakya, Noida (IN)

(21) Appl. No.: 15/675,646

(22) Filed: Aug. 11, 2017

(30) Foreign Application Priority Data
Mar. 10, 2017 (IN) 201721008529

(51) Int. Cl. H04W 36/18; H04W 36/02; H04W 36/00; H04W 8/26; H04W 48/16; H04W 4/00

(52) U.S. Cl. CPC H04W 36/18; H04W 36/0016; H04W 8/26; H04W 36/02; H04W 4/001; H04W 48/16

(57) ABSTRACT

Concepts and examples pertaining to virtual roaming are described. A processor of an electronic apparatus hosts a main repeater and one or more virtual repeaters by functioning as the main repeater and the one or more virtual repeaters with each of the one or more virtual repeaters mimicking a respective one of one or more remote repeaters. The processor services a station by communicating with the station as the main repeater. The processor requests a first remote repeater of the one or more remote repeaters to service the station. The processor also ceases to service the station upon completion of handoff of the station to the first remote repeater.

### CROSS REFERENCE TO RELATED PATENT APPLICATION(S)

The present disclosure claims the priority benefit of India Provisional Patent Application No. 201721008529, filed 10 Mar. 2017, the content of which is incorporated by reference in its entirety.

### TECHNICAL FIELD

The present disclosure is generally related to computer networking and, more particularly, to virtual roaming methods and apparatus thereof.

### BACKGROUND

Unless otherwise indicated herein, approaches described in this section are not prior art to the claims listed below and are not admitted to be prior art by inclusion in this section.

In a network with multiple wireless repeaters and/or access points (APs) with the same service set identifier (SSID) and security settings, a user of a user equipment or station (STA) may desire to roam from a first repeater/AP to a second repeater/AP when signal strength on the second repeater/AP is better than that of the first repeater/AP. The ability to roam from one repeater/AP with a weaker signal strength to another repeater/AP with a stronger signal strength helps to improve performance as it improves unicast packets data rates. However, most if not all existing roaming algorithms implemented in STAs do not always switch from one repeater/AP to another repeater/AP until the received signal strength indicator (RSSI) of the repeater/AP to which the STA is connected becomes really bad (e.g., <−70 dB). For example, a STA may be receiving an RSSI of −70 dB from its repeater/AP, yet the STA may be unaware of a better repeater/AP in the surrounding, which may provide an RSSI of −50 dB. The roaming algorithm executed by the STA may not trigger the roaming or switching until the RSSI deteriorates to a point of <−70 dB.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose various novel concepts and schemes pertaining to virtual roaming.

In one aspect, a method may involve a processor of an electronic apparatus hosting a main repeater and one or more virtual repeaters by functioning as the main repeater and the one or more virtual repeaters with each of the one or more virtual repeaters mimicking a respective one of one or more remote repeaters. The method may involve the processor servicing a station by communicating with the station as the main repeater. The method may also involve the processor requesting a first remote repeater of the one or more remote repeaters to service the station. The method may further involve the processor ceasing to service the station upon completion of handoff of the station to the first remote repeater.

In one aspect, a method may involve a processor of an electronic apparatus hosting a main repeater and one or more virtual repeaters by functioning as the main repeater and the one or more virtual repeaters with each of the one or more virtual repeaters mimicking a respective one of one or more remote repeaters. The method may also involve the processor receiving a request from a first remote repeater to service a station. The method may further involve the processor servicing the station by communicating with the station as a first virtual repeater of the one or more virtual repeaters that mimics the first remote repeater responsive to the receiving of the request.

In one aspect, an electronic apparatus may include a processor. The processor may include a repeater hosting circuit and a communication circuit. The repeater hosting circuit may be capable of hosting a main repeater and one or more virtual repeaters by functioning as the main repeater and the one or more virtual repeaters with each of the one or more virtual repeaters mimicking a respective one of one or more remote repeaters. The communication circuit may be capable of communicating with one or more stations and one or more remote repeaters with respect to servicing the one or more stations. The repeater hosting circuit may host the main repeater by broadcasting a media access control (MAC) address associated with the apparatus as a basic service set identifier (BSSID) of a basic service set (BSS) corresponding to the main repeater. The repeater hosting circuit may also host the one or more virtual repeaters by broadcasting a MAC address associated with the first remote repeater as a BSSID of a BSS corresponding to a first virtual repeater of the one or more virtual repeaters that mimics the first remote repeater.

It is noteworthy that, although description provided herein may be in the context of virtual roaming in a repeater network, the proposed concepts, schemes and any variation(s)/derivative(s) thereof may be implemented for other types of apps or applications to render virtual roaming. For instance, the proposed concepts, schemes and any variation(s)/derivative(s) thereof in accordance with the present disclosure may be utilized in other types of networks to render virtual roaming. Thus, the scope of the proposed schemes is not limited to the description provided herein.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network in which various schemes in accordance with the present disclosure may be implemented.

FIG. 2 is a block diagram of an example apparatus in accordance with an implementation of the present disclosure.

FIG. 3 is a flowchart of an example process in accordance with an implementation of the present disclosure.

FIG. 4 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

The present disclosure introduces a concept of multiple basic service sets (MBSS) under which a single communication device/apparatus can host multiple independent repeaters/APs in a network. The repeaters/APs implementing the MBSS concept may have dedicated media access control (MAC) resources and share common radio resources on time-sharing basis. The repeaters/APs implementing the MBSS concept may operate on the same wireless channel(s). For simplicity, the following description is provided in the context of repeater networks. It would be appreciated by those skilled in the art that the concept described herein is also applicable to AP networks. Moreover, within a single communication device/apparatus, a repeater associated with a first basic service set (BSS) is referred as the “main repeater” while other repeaters associated with other basic service sets are referred as “virtual repeaters.”

Under the MBSS concept and various schemes of the present disclosure, a repeater with the best or strongest RSSI may service a STA without relying upon the STA to make roaming decisions. The main BSS associated with the main repeater may beacon with its own MAC address as the BSS identifier (BSSID). Each repeater may be associated with a respective and dedicated BSS corresponding to other repeaters in the network. Each of the secondary BSS's associated with virtual repeaters may use BSSIDs of other repeaters as its MAC, thereby mimicking other repeaters present in the network. The virtual repeaters may not beacon frames or probe response frames. The virtual repeaters also may not send response frames, such as acknowledgment (ACK), block acknowledgment (BA), clear-to-send (CTS) and the like, until and unless explicitly programmed to do so.

Under a proposed scheme, a main repeater on each communication device may communicate with repeaters on other communication devices in the network to identify a “best repeater” (e.g., one with stronger or better RSSI for a STA in concern than other repeaters in the network) to service one or more STAs currently connected to the respective repeater. Upon finding or otherwise identifying the best repeater (e.g., one with stronger or better RSSI), a repeater may request the identified best repeater to start servicing a STA currently connected to the requesting repeater. How a best repeater is identified or selected is beyond the scope of the present disclosure and is not described herein.

Under a proposed scheme, the best repeater may use one of its virtual repeaters to replicate the main repeater, from which the STA is to roam, to service the STA. The virtual repeater may start sending response frames (e.g., ACK/BA) to the STA. The virtual repeater may also process and forward packets received from the STA. All downlink data to the STA may pass through the virtual repeater. Once the handoff from the main repeater to the virtual repeater is complete, the main repeater may stop servicing the STA. In particular, the main repeater may stop sending response frames to the STA and start discarding packets received from the STA.

Under a proposed scheme, the main repeater on a communication device, not the virtual repeaters, may beacon or otherwise transmit or broadcast beacon frames (e.g., as with normal APs). The main repeater may be configured to stop sending response frames to a specified set of stations.

Under a proposed scheme, each communication device may host one dedicated virtual repeater corresponding to (e.g., mimicking) a main repeater hosted by another communication device in the network. For instance, if the network includes five communication devices, each of the five communication devices may have a respective main repeater and four virtual repeaters each of which corresponding to a respective one of the main repeaters of the other four communication devices in the network. Under the proposed scheme, virtual repeaters may not beacon or send any response frames. Moreover,

virtual repeaters may have transmitter (TX) and receiver (RX) functions disabled by default. When a virtual repeater needs to service a station, all required parameters (e.g., security keys, MAC sublayer management entity (MLME) states and the like) may be configured by the repeater which was previously servicing the station. After all configurations are transferred from a repeater (whether main repeater or virtual repeater) previously servicing the station to a virtual repeater currently servicing the station, the virtual repeater may start its TX/RX functions for the particular station (but not for other stations in the network). Once the virtual repeater takes on the servicing of the station, the repeater previously servicing the station (interchangeably referred as the “previous repeater”) may stop servicing the station. For instance, the previous repeater may stop sending any response frames to the station. The previous repeater may also stop processing any packets received from the station.

Under a proposed scheme, the transfer of data path from a main repeater to a virtual repeater may involve the transfer of MLME states, synchronization of sequence numbers, and routing table update. With respect to the transfer of MLME states, the virtual repeater may create a station entry in its list of connected station(s). The main repeater may share various wireless parameters about the station (e.g., supported rates, wireless mode and the like), which were otherwise shared at the time of association. The main repeater may also share the pairwise transient key (PTK) with the virtual repeater before the virtual repeater creates the station entry and starts servicing the station.

With respect to the synchronization of sequence numbers, when the main repeater switches the data path for one of its peer to one of its virtual repeaters, the TX/RX sequence numbers may change. In order to gracefully update the sequence numbers, the main repeater may tear down any existing block acknowledgment (BA) session. The main repeater may send out a del-BA request and flush out all the packets in its queue. The virtual repeater may then trigger a new BA session. With respect to routing table update, the virtual repeater may broadcast a gratuitous address resolution protocol (ARP) frame on behalf of the station in order to redirect data for the station through the virtual repeater.

Under a proposed scheme, broadcast packets may only be forwarded by the main repeater. As virtual repeaters and the main repeater are part of the same network, broadcast frames are transmitted by the main repeater under the proposed scheme. Broadcast frames for a particular BSS may be forwarded by the same BSS. However, in this case, the same station may be serviced by two BSS's (a main repeater and a virtual repeater) and hence the station may receive two copies of the broadcast packets. This might affect applications working on broadcast traffic. When a station is able to listen to a beacon frame, the station may be able to listen to broadcast frames as well. In cases when a station is in a power-save (PS) mode, broadcast frames need to be forwarded by the main repeater at a delivery traffic indication message (DTIM), as the main repeater handles the beacon transmission.

Under a proposed scheme, a new group key may be derived by the main repeater. The main repeater may block all broadcast packets. The main repeater may also share the group key with all connected stations as well as with all virtual repeaters hosted on other communication devices. Each virtual repeater may share the group key with station(s) it is servicing on behalf of the main repeater. The virtual repeaters may send a confirmation message to the main repeater, and the main repeater may resume transmission of broadcast packets upon receiving the confirmation.

Under a proposed scheme, when a station currently serviced by a virtual repeater enters the PS mode, special handling may be required while sending buffered packets. The packets may be buffered at the virtual repeater while the station is in sync with the beacons of the actual repeater to which the station is connected. The traffic indication map (TIM) bit in the beacon of the actual repeater may reflect status of buffered packets in the virtual repeater. Hence, the virtual repeater may update the main repeater with its buffered traffic status as well as provide information on servicing the station entering and leaving the PS mode for related TIM and broadcast packet handling. The main repeater may update the TIM bit in its next beacon accordingly.

Under a proposed scheme, multicast packets may be handled using Internet Group Management Protocol (IGMP) snooping. Repeaters may listen to IGMP join request(s) from one or more connected station(s), and send a IGMP join message for the multicast address to adjacent repeaters. When a station needs to be moved to a virtual repeater, a main repeater may share all the multicast addresses which the station is listening with the virtual repeater. The virtual repeater may send an IGMP join message for the multicast addresses to other repeaters, if the virtual repeater is not already listening to such addresses. When a repeater receives a multicast packet, it may forward the multicast packet as a unicast packet to all the stations which have registered for the multicast address. It would be appreciated by those skilled in the art that the proposed scheme is helpful as data can be transferred as unicast packets at much higher rates compared to multicast packets.

Under a proposed scheme, when IGMP snooping is not enabled, multicast packets may be sent as-is just like broadcast packets. In such cases the main repeater, not the virtual repeaters, may transmit multicast packets.

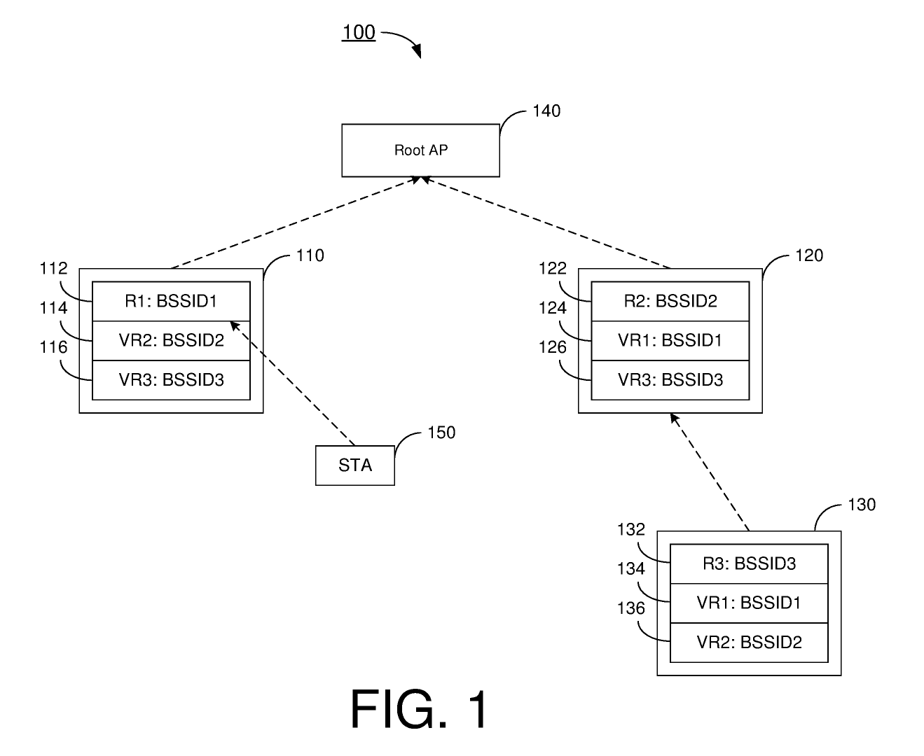

FIG. 1 illustrates an example network 100 in which various schemes in accordance with the present disclosure may be implemented. Network 100 may involve a root AP 140 and a number of communication devices, such as communication devices 110, 120 and 130, with one or more of the communication devices 110-130 communicatively connected to root AP 140 directly. Network 100 may also involve a user equipment or station, such as STA 150, communicatively connected to root AP 140 via one of communication devices 110-130. In the example shown in FIG. 1, communication device 110 and communication device 120 are communicatively connected to root AP 140 directly. Also, in the example shown in FIG. 1, communication device 130 is communicatively connected to communication device 120 directly.

Each of communication devices 110-130 may be designed, adapted or otherwise configured to implement the MBSS concept and various schemes in accordance with the present disclosure. Accordingly, each of communication devices 110-130 may be capable of hosting multiple independent repeaters, with one of the multiple repeaters being the main repeater and remaining ones of the multiple repeaters being virtual repeaters. In the example shown in FIG. 1, communication device 110 hosts three repeaters, namely repeater 112, repeater 114 and repeater 116. In this example, repeater 112 functions as the main repeater (labeled as “R1” in FIG. 1) hosted by communication device 110, and uses the MAC address of communication device 110 (e.g., “BSSID1”) as its BSSID. Each of repeater 114 and repeater 116 functions as a respective virtual repeater (labeled as “VR2” and “VR3”, respectively, in FIG. 1) hosted by communication device 110. In this example, repeater 114 mimics or otherwise replicates the main repeater hosted by communication device 120, and uses the MAC address of communication device 120 (e.g., “BSSID2”) as its BSSID. Similarly, repeater 116 mimics or otherwise replicates the main repeater hosted by communication device 130, and uses the MAC address of communication device 130 (e.g., “BSSID3”) as its BSSID.

Additionally, in the example shown in FIG. 1, communication device 120 hosts three repeaters, namely repeater 122, repeater 124 and repeater 126. In this example, repeater 122 functions as the main repeater (labeled as “R2” in FIG. 1) hosted by communication device 120, and uses the MAC address of communication device 120 (e.g., “BSSID2”) as its BSSID. Each of repeater 124 and repeater 126 functions as a respective virtual repeater (labeled as “VR1” and “VR3”, respectively, in FIG. 1) hosted by communication device 120. In this example, repeater 124 mimics or otherwise replicates the main repeater hosted by communication device 110, and uses the MAC address of communication device 110 (e.g., “BSSID1”) as its BSSID. Similarly, repeater 126 mimics or otherwise replicates the main repeater hosted by communication device 130, and uses the MAC address of communication device 130 (e.g., “BSSID3”) as its BSSID.

Moreover, in the example shown in FIG. 1, communication device 130 hosts three repeaters, namely repeater 132, repeater 134 and repeater 136. In this example, repeater 132 functions as the main repeater (labeled as “R3” in FIG. 1) hosted by communication device 130, and uses the MAC address of communication device 130 (e.g., “BSSID3”) as its BSSID. Each of repeater 134 and repeater 136 functions as a respective virtual repeater (labeled as “VR1” and “VR2”, respectively, in FIG. 1) hosted by communication device 130. In this example, repeater 134 mimics or otherwise replicates the main repeater hosted by communication device 110, and uses the MAC address of communication device 110 (e.g., “BSSID1”) as its BSSID. Similarly, repeater 136 mimics or otherwise replicates the main repeater hosted by communication device 120, and uses the MAC address of communication device 120 (e.g., “BSSID2”) as its BSSID.

In the example shown in FIG. 1, STA 150 is initially in communicative connection with repeater 112, the main repeater hosted by communication device 110. When repeater 112 (or communication device 110) determines that STA 150 should roam to repeater 122 (e.g., due to the RSSI associated with repeater 122 being stronger than the RSSI associated with repeater 112), repeater 112 may request repeater 122 to start servicing STA 150. Repeater 122 may enable repeater 124, which corresponds to repeater 112 as repeater 124 functions as a virtual repeater of repeater 112 (VR1), to start servicing STA 150. Repeater 112 (R1) in communication device 110 may stop servicing STA 150 at this point. Later, when STA 150 moves to a location closer to repeater 132 than repeater 122 (and thereby resulting in the RSSI associated with repeater 132 being stronger than the RSSI associated with repeater 122), repeater 122 may request repeater 132 to start servicing STA 150. Repeater 132 may enable repeater 136, which corresponds to repeater 122 as repeater 136 functions as a virtual repeater of repeater 122 (VR2), to start servicing STA 150. Repeater 124 (VR1) in communication device 120 may stop servicing STA 150 at this point. As a result of above actions, repeater 122 (R2) and repeater 132 (R3) may act on behalf of repeater 112 (R1) by autonomously roaming or assisting the roaming of STA 150 from one repeater to another. Consequently, STA 150 may roam from R1 to R2, and from R2 to R3, unknowingly. In other words, there is no effort or decision-making on the part of STA 150 as it roams around from one repeater to another under the proposed scheme.

In view of the above example, it can be seen that the proposed scheme advantageously provides the ability for a station to quickly roam from one repeater/AP to another with a better RSSI. When virtual repeaters are not used, most stations under the conventional approaches would trigger roaming only at a lower RSSI level (e.g., −75 dB). However, if the station continues to receive a moderate RSSI (e.g., between −60 dB and −70 dB), the station may not trigger roaming and may continue to operate at moderate but not optimal data rates. When virtual repeaters in accordance with the present disclosure are deployed, the virtual repeaters may provide higher data rates for unicast packets as well as multicast packets (e.g., converted to unicast by IGMP snooping). Once the station reaches its natural roaming point, the involved virtual repeater(s) may hand off the station back to the main repeater, thereby forcing the station to roam.

### Illustrative Implementations

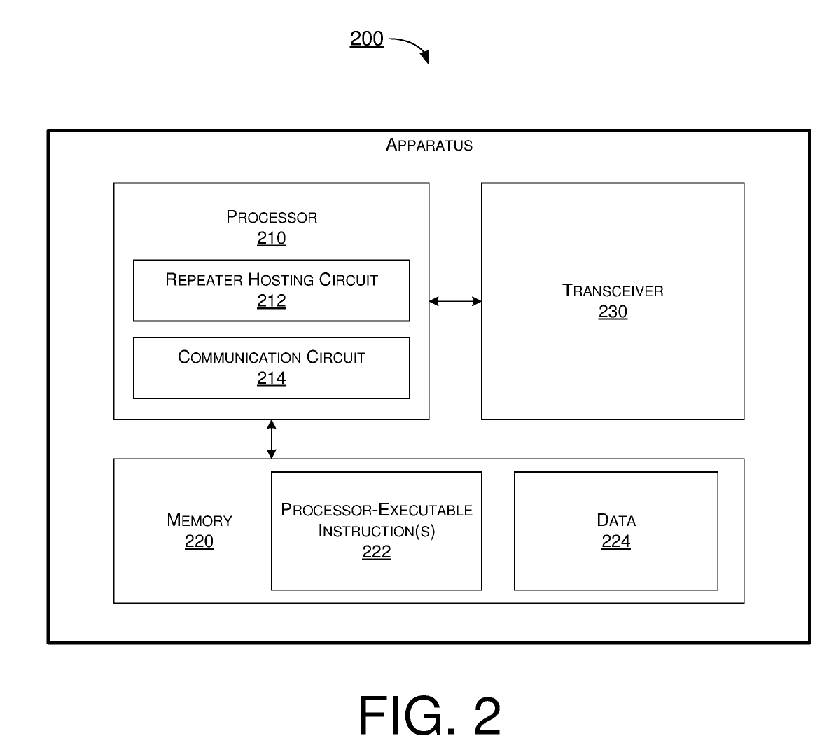

FIG. 2 illustrates an example apparatus 200 in accordance with an implementation of the present disclosure. Apparatus 200 may perform various functions to implement schemes, techniques, processes and methods described herein pertaining to virtual roaming such as the various schemes described above as well as process 300 and process 400 described below. For

instance, apparatus 200 may be an example implementation of each of communication devices 110, 120 and 130 in network 100.

Apparatus 200 may be a part of an electronic apparatus which may be a communication device, a computing apparatus, a portable or mobile apparatus, or a wearable apparatus. For instance, apparatus 200 may be implemented in or as a repeater, a Wi-Fi access point, a smartphone, a smartwatch, a smart bracelet, a smart necklace, a personal digital assistant, or a computing device such as a tablet computer, a laptop computer, a notebook computer, a desktop computer, or a server. Alternatively, apparatus 200 may be implemented in the form of one or more integrated-circuit (IC) chips such as, for example and not limited to, one or more single-core processors, one or more multi-core processors, or one or more complex-instruction-set-computing (CISC) processors.

Apparatus 200 may include at least some of those components shown in FIG. 2 such as a processor 210, for example. Apparatus 200 may further include one or more other components not pertinent to the proposed schemes of the present disclosure (e.g., internal power supply, display device and/or user interface device), and, thus, such component(s) of apparatus 200 are neither shown in FIG. 2 nor described below in the interest of simplicity and brevity.

In one aspect, processor 210 may be implemented in the form of one or more single-core processors, one or more multi-core processors, or one or more CISC processors. That is, even though a singular term “a processor” is used herein to refer to processor 210, processor 210 may include multiple processors in some implementations and a single processor in other implementations in accordance with the present disclosure. In another aspect, processor 210 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, processor 210 is a special-purpose machine specifically designed, arranged and configured to perform specific tasks pertaining to virtual roaming in accordance with various implementations of the present disclosure.

In some implementations, apparatus 200 may also include a transceiver 230 coupled to processor 210 and capable of wirelessly transmitting and receiving data. Transceiver 230 may be configured to communicate wirelessly with one or more stations and one or more other repeaters as multiple repeaters. For instance, transceiver 230 may communicate wirelessly for a main repeater and one or more virtual repeaters hosted by processor 210.

In some implementations, apparatus 200 may also include a memory 220 accessible by processor 210. Memory 220 may be a storage device configured to store one or more sets of codes, programs and/or instructions 222 as well as data 224 therein. For example, memory 220 may be operatively coupled to processor 210 to receive and store data 224. Memory 220 may be implemented by any suitable technology and may include volatile memory and/or non-volatile memory. For example, memory 220 may include a type of random access memory (RAM) such as dynamic RAM (DRAM), static RAM (SRAM), thyristor RAM (T-RAM) and/or zero-capacitor RAM (Z-RAM). Alternatively or additionally, memory 220 may include a type of read-only memory (ROM) such as mask ROM, programmable ROM (PROM), erasable programmable ROM (EPROM) and/or electrically erasable programmable ROM (EEPROM). Alternatively or additionally, memory 220 may include a type of non-volatile random-access memory (NVRAM) such as flash memory, solid-state memory, ferroelectric RAM (FeRAM), magnetoresistive RAM (MRAM) and/or phase-change memory.

Processor 210 may be implemented in the form of one or more single-core processors, one or more multi-core processors, or one or more CISC processors. That is, processor 210 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure.

In some implementations, processor 210 may access memory 220 to execute the one or more instructions stored in memory 220. Upon executing the one or more sets of instructions, processor 210 may be configured to perform operations pertaining to virtual roaming in accordance with the present disclosure. In some implementations, processor 210 may include a repeater hosting circuit 212 and a communication circuit 214 that are designed, adapted or otherwise configured to achieve specific purposes, such as virtual roaming, in accordance with the present disclosure.

For instance, repeater hosting circuit 212 may be capable of hosting a main repeater (e.g., repeater 112 (R1), repeater 122 (R2) or repeater 132 (R3)) and one or more virtual repeaters (e.g., repeaters 114 and 116 (VR2 and VR3), repeaters 124 and 126 (VR1 and VR3), or repeaters 134 and 136 (VR1 and VR2)) by functioning as the main repeater and the one or more virtual repeaters with each of the one or more virtual repeaters mimicking a respective one of one or more remote repeaters (e.g., VR1 mimicking R1, VR2 mimicking R2, and VR3 mimicking R3). Repeater hosting circuit 212 may host the main repeater by broadcasting a MAC address associated with the apparatus as a BSSID of a BSS corresponding to the main repeater. Moreover, repeater hosting circuit 212 may host the one or more virtual repeaters by broadcasting a MAC address associated with the first remote repeater as a BSSID of a BSS corresponding to a first virtual repeater of the one or more virtual repeaters that mimics the first remote repeater. Communication circuit 214 may be capable of communicating with one or more stations (e.g., STA 150 and other station(s) (not shown in FIG. 1)) and one or more remote repeaters with respect to servicing the one or more stations.

In some implementations, processor 210 may be capable of hosting the main repeater to service a first station (e.g., STA 150) of the one or more stations by performing a number of operations. For instance, repeater hosting circuit 212 may service the first station by communicating, via transceiver 230, with the first station as the main repeater. Communication circuit 214 may request, via transceiver 230, a first remote repeater of the one or more remote repeaters to service the first station. Moreover, repeater hosting circuit 212 may cease to service the first station upon completion of handoff of the first station to the first remote repeater.

Additionally or alternatively, processor 210 may be capable of hosting a first virtual repeater of the one or more virtual repeaters to service a second station of the one or more stations by performing a number of operations. For instance, communication circuit 214 may receive a request from a second remote repeater of the one or more remote repeaters to service the second station. Furthermore, repeater hosting circuit 212 may service the second station by communicating with the second station as the first virtual repeater which mimics the second remote repeater responsive to the receiving of the request.

Further detailed description of additional capabilities and functions of processor 210 is provided below with respect to processes 300 and 400. Thus, in the interest of brevity, such detailed description is not provided here to avoid repetition.

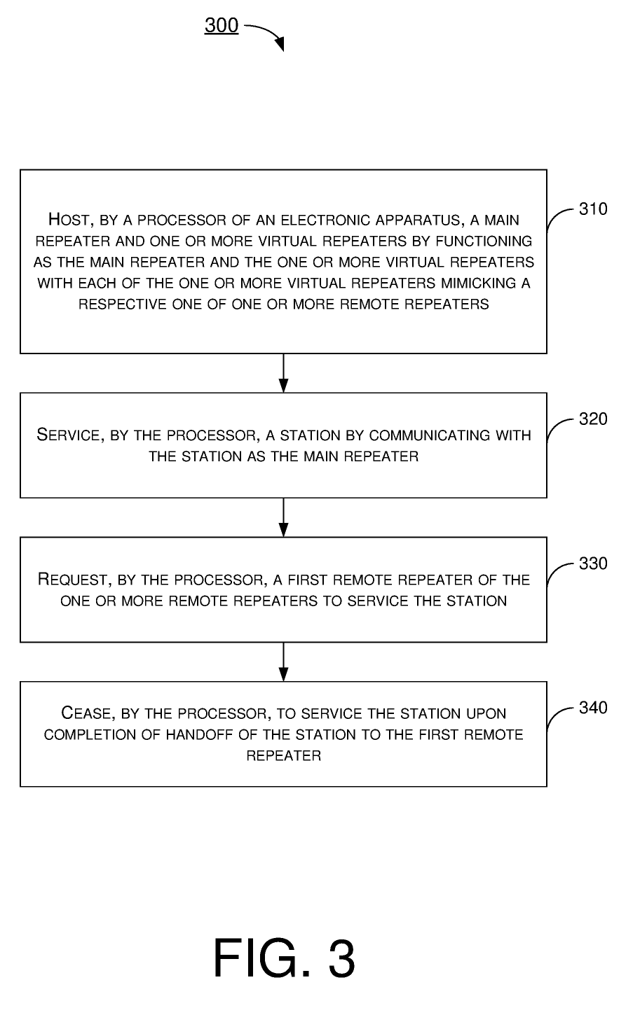

FIG. 3 illustrates an example process 300 in accordance with an implementation of the present disclosure. Process 300 may represent an aspect of implementing the proposed concepts and schemes described above. More specifically, process 300 may represent an aspect of the proposed concepts and schemes pertaining to virtual roaming. For example, process 300 may represent an example implementation of functions of repeater 112 (R1) as a main repeater in network 100 as described above. Process 300 may include one or more operations, actions, or functions as illustrated by one or more of blocks 310, 320, 330 and 340. Although illustrated as discrete blocks, various blocks of process 300 may be divided into additional blocks, combined into fewer blocks, or eliminated, depending on the desired implementation. Moreover, the blocks/sub-blocks of process 300 may be executed in the order shown in FIG. 3 or, alternatively in a different order. The blocks/sub-blocks of process 300 may be executed iteratively. Process 300 may be implemented by or in apparatus 200 as well as any variations thereof. Solely for illustrative purposes and without limiting the scope, process 300 is described below in the context of apparatus 200. Process 300 may begin at block 310.

At 310, process 300 may involve processor 210 of apparatus 200 hosting a main repeater and one or more virtual repeaters by functioning as the main repeater and the one or more virtual repeaters with each of the one or more virtual repeaters mimicking a respective one of one or more remote repeaters. Process 300 may proceed from 310 to 320.

At 320, process 300 may involve processor 210 servicing a station by communicating with the station as the main repeater. Process 300 may proceed from 320 to 330.

At 330, process 300 may involve processor 210 requesting a first remote repeater of the one or more remote repeaters to service the station. Process 300 may proceed from 330 to 340.

At 340, process 300 may involve processor 210 ceasing to service the station upon completion of handoff of the station to the first remote repeater.

In some implementations, in hosting the main repeater, process 300 may involve processor 210 broadcasting a MAC address associated with the electronic apparatus as a BSSID of a BSS corresponding to the main repeater.

In some implementations, in hosting the one or more virtual repeaters, process 300 may involve processor 210 broadcasting a MAC address associated with the first remote repeater as a BSSID of a BSS corresponding to a first virtual repeater of the one or more virtual repeaters that mimics the first remote repeater.

In some implementations, in requesting the first remote repeater of the one or more remote repeaters to service the station, process 300 may involve processor 210 setting a value of each of one or more parameters pertaining to servicing the station. Additionally, process 300 may involve processor 210 transmitting information of the one or more parameters to the first remote repeater to configure the first virtual repeater to service the station.

In some implementations, in ceasing to service the station, process 300 may involve processor 210 refraining from sending response frames to the station. Moreover, process 300 may involve processor 210 discarding packets received from the station.

In some implementations, process 300 may involve processor 210 performing a number of additional operations. For instance, process 300 may involve processor 210 generating a group key as the main repeater. Additionally, process 300 may involve processor 210 blocking transmission of broadcast packets. Moreover, process 300 may involve processor 210 sharing the group key with one or more stations in communicative connection with the main repeater. Furthermore, process 300 may involve processor 210 sharing the group key with one or more other virtual repeaters hosted by one or more communication devices. In some implementations, process 300 may additionally involve processor 210 receiving a confirmation regarding the sharing of the group key from each of the one or more other virtual repeaters. Moreover, process 300 may involve processor 210 resuming the transmission of the broadcast packets.

In some implementations, process 300 may involve processor 210 performing a number of additional operations. For instance, process 300 may involve processor 210 receiving from the first virtual repeater an update on status of packets buffered by the first remote repeater for the station. Moreover, process 300 may involve processor 210 receiving from the first virtual repeater an indication on status of power-save with respect to the station. Furthermore, process 300 may involve processor 210 updating a traffic indication map (TIM) bit to reflect the status of the packets buffered by the first virtual repeater for the station. Additionally, process 300 may involve processor 210 transmitting a beacon with the updated TIM bit.

In some implementations, process 300 may involve processor 210 performing a number of additional operations. For instance, process 300 may involve processor 210 receiving an IGMP join request from the station. Moreover, process 300 may involve processor 210 sharing with the first virtual repeater one or more multicast addresses which the station is listening.

In some implementations, process 300 may involve processor 210 performing a number of additional operations. For instance, process 300 may involve processor 210 receiving one or more multicast packets for which the station is a recipient. Furthermore, process 300 may involve processor 210 transmitting the multicast packets to the station.

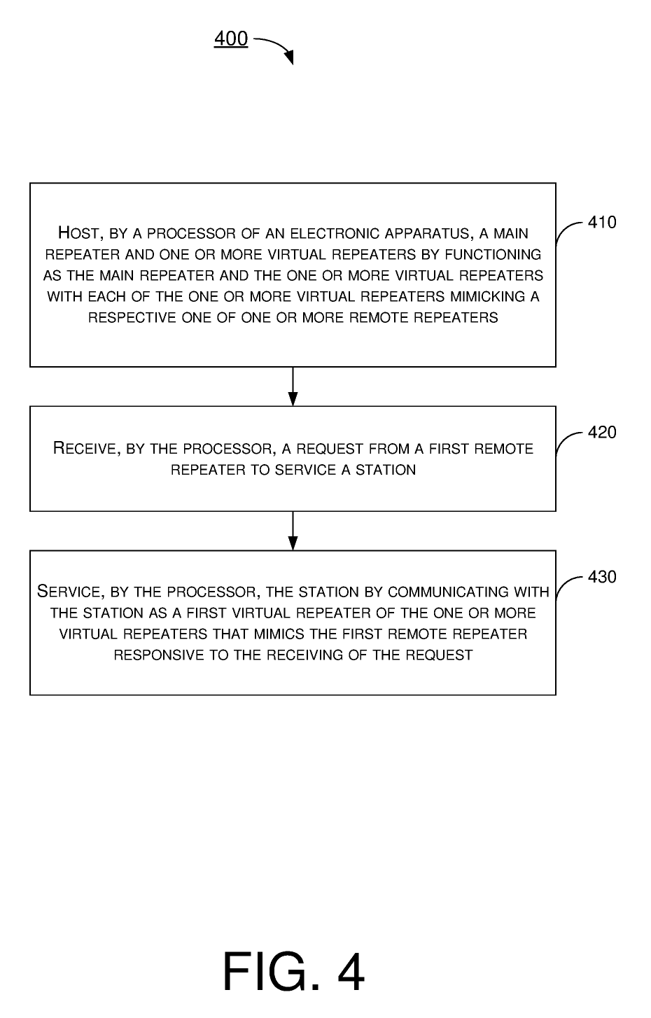

FIG. 4 illustrates an example process 400 in accordance with an implementation of the present disclosure. Process 400 may represent an aspect of implementing the proposed concepts and schemes described above. More specifically, process 400 may represent an aspect of the proposed concepts and schemes pertaining to virtual roaming. For example, process 400 may represent an example implementation of functions of repeater 124 (VR1) or repeater 134 (VR1) as a virtual repeater in network 100 as described above. Process 400 may include one or more operations, actions, or functions as illustrated by one or more of blocks 410, 420, 430 and 440. Although illustrated as discrete blocks, various blocks of process 400 may be divided into additional blocks, combined into fewer blocks, or eliminated, depending on the desired implementation. Moreover, the blocks/sub-blocks of process 400 may be executed in the order shown in FIG. 4 or, alternatively in a different order. The blocks/sub-blocks of process 400 may be executed iteratively. Process 400 may be implemented by or in apparatus 200 as well as any variations thereof. Solely for illustrative purposes and without limiting the scope, process 400 is described below in the context of apparatus 200. Process 400 may begin at block 410.

At 410, process 400 may involve processor 210 of apparatus 200 hosting a main repeater and one or more virtual repeaters by functioning as the main repeater and the one or more virtual repeaters with each of the one or more virtual repeaters mimicking a respective one of one or more remote repeaters. Process 400 may proceed from 410 to 420.

At 420, process 400 may involve processor 210 receiving a request from a first remote repeater to service a station. Process 400 may proceed from 420 to 430.

At 430, process 400 may involve processor 210 servicing the station by communicating with the station as a first virtual repeater of the one or more virtual repeaters that mimics the first remote repeater responsive to the receiving of the request.

In some implementations, in hosting the main repeater, process 400 may involve processor 210 broadcasting a MAC address associated with the electronic apparatus as a BSSID of a BSS corresponding to the main repeater.

In some implementations, in hosting the one or more virtual repeaters, process 400 may involve processor 210 broadcasting a MAC address associated with a first remote repeater of the one or more remote repeaters as a BSSID of a BSS corresponding to a first virtual repeater of the one or more virtual repeaters that mimics the first remote repeater.

In some implementations, in receiving the request to service the station, process 400 may involve processor 210 receiving information of one or more parameters pertaining to servicing the station. Additionally, process 400 may involve processor 210 setting a value of each of the one or more parameters to configure the first virtual repeater to service the station.

In some implementations, in servicing the station, process 400 may involve processor 210 sending response frames to the station. Moreover, process 400 may involve processor 210 processing packets received from the station.

In some implementations, process 400 may involve processor 210 performing a number of additional operations. For instance, process 400 may involve processor 210 receiving a group key from the first remote repeater. Additionally, process 400 may involve processor 210 sharing the group key with one or more stations in communicative connection with the first virtual repeater. Moreover, process 400 may involve processor 210 transmitting a confirmation regarding the group key to the first remote repeater.

In some implementations, process 400 may involve processor 210 performing a number of additional operations. For instance, process 400 may involve processor 210 transmitting to the first remote repeater an update on status of packets buffered by the first virtual repeater for the station. Moreover, process 400 may involve processor 210 transmitting to the first remote repeater an indication on status of power-save with respect to the station.

In some implementations, process 400 may involve processor 210 performing a number of additional operations. For instance, process 400 may involve processor 210 receiving one or more multicast addresses which the station is listening. Moreover, process 400 may involve processor 210 transmitting an IGMP join message for the one or more multicast addresses to one or more other repeaters.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
hosting, by a processor of an electronic apparatus, a main repeater and one or more virtual repeaters by functioning as the main repeater and the one or more virtual repeaters with each of the one or more virtual repeaters mimicking a respective one of one or more remote repeaters;
servicing, by the processor, a station by communicating with the station as the main repeater;
requesting, by the processor, a first remote repeater of the one or more remote repeaters to service the station; and
ceasing, by the processor, to service the station upon completion of handoff of the station to the first remote repeater.

2. The method of claim 1, wherein the hosting of the main repeater comprises broadcasting a media access control (MAC) address associated with the electronic apparatus as a basic service set identifier (BSSID) of a basic service set (BSS) corresponding to the main repeater.

3. The method of claim 1, wherein the hosting of the one or more virtual repeaters comprises broadcasting a media access control (MAC) address associated with the first remote repeater as a basic service set identifier (BSSID) of a basic service set (BSS) corresponding to a first virtual repeater of the one or more virtual repeaters that mimics the first remote repeater.

4. The method of claim 1, wherein the requesting the first remote repeater of the one or more remote repeaters to service the station comprises:
setting a value of each of one or more parameters pertaining to servicing the station; and
transmitting information of the one or more parameters to the first remote repeater to configure the first virtual repeater to service the station.

5. The method of claim 1, wherein the ceasing to service the station comprises:
refraining from sending response frames to the station; and
discarding packets received from the station.

6. The method of claim 1, further comprising:
generating, by the processor, a group key as the main repeater;
blocking, by the processor, transmission of broadcast packets;
sharing, by the processor, the group key with one or more stations in communicative connection with the main repeater; and
sharing, by the processor, the group key with one or more other virtual repeaters hosted by one or more communication devices.

7. The method of claim 6, further comprising:
receiving, by the processor, a confirmation regarding the sharing of the group key from each of the one or more other virtual repeaters; and
resuming, by the processor, the transmission of the broadcast packets.

8. The method of claim 1, further comprising:
receiving, by the processor, from the first virtual repeater an update on status of packets buffered by the first remote repeater for the station;
receiving, by the processor, from the first virtual repeater an indication on status of power-save with respect to the station;
updating, by the processor, a traffic indication map (TIM) bit to reflect the status of the packets buffered by the first virtual repeater for the station; and
transmitting, by the processor, a beacon with the updated TIM bit.

9. The method of claim 1, further comprising:
receiving, by the processor, an Internet Group Management Protocol (IGMP) join request from the station; and
sharing, by the processor, with the first virtual repeater one or more multicast addresses which the station is listening.

10. The method of claim 1, further comprising:
receiving, by the processor, one or more multicast packets for which the station is a recipient; and
transmitting, by the processor, the multicast packets to the station.

11. A method, comprising:
hosting, by a processor of an electronic apparatus, a main repeater and one or more virtual repeaters by functioning as the main repeater and the one or more virtual repeaters with each of the one or more virtual repeaters mimicking a respective one of one or more remote repeaters;
receiving, by the processor, a request from a first remote repeater to service a station; and
servicing, by the processor, the station by communicating with the station as a first virtual repeater of the one or more virtual repeaters that mimics the first remote repeater responsive to the receiving of the request.

12. The method of claim 11, wherein the hosting of the main repeater comprises broadcasting a media access control (MAC) address associated with the electronic apparatus as a basic service set identifier (BSSID) of a basic service set (BSS) corresponding to the main repeater.

13. The method of claim 11, wherein the hosting of the one or more virtual repeaters comprises broadcasting a media access control (MAC) address associated with a first remote repeater of the one or more remote repeaters as a basic service set identifier (BSSID) of a basic service set (BSS) corresponding to a first virtual repeater of the one or more virtual repeaters that mimics the first remote repeater.

14. The method of claim 11, wherein the receiving of the request to service the station comprises:
receiving information of one or more parameters pertaining to servicing the station; and
setting a value of each of the one or more parameters to configure the first virtual repeater to service the station.

15. The method of claim 11, wherein the servicing of the station comprises:
sending response frames to the station; and
processing packets received from the station.

16. The method of claim 11, further comprising:
receiving, by the processor, a group key from the first remote repeater;
sharing, by the processor, the group key with one or more stations in communicative connection with the first virtual repeater; and
transmitting, by the processor, a confirmation regarding the group key to the first remote repeater.

17. The method of claim 11, further comprising:
transmitting, by the processor, to the first remote repeater an update on status of packets buffered by the first virtual repeater for the station; and
transmitting, by the processor, to the first remote repeater an indication on status of power-save with respect to the station.

18. The method of claim 11, further comprising:
receiving, by the processor, one or more multicast addresses which the station is listening; and
transmitting, by the processor, an Internet Group Management Protocol (IGMP) join message for the one or more multicast addresses to one or more other repeaters.

19. An apparatus, comprising:
a processor comprising:
a repeater hosting circuit capable of hosting a main repeater and one or more virtual repeaters by functioning as the main repeater and the one or more virtual repeaters with each of the one or more virtual repeaters mimicking a respective one of one or more remote repeaters; and
a communication circuit capable of communicating with one or more stations and one or more remote repeaters with respect to servicing the one or more stations,
wherein the repeater hosting circuit hosts the main repeater by broadcasting a media access control (MAC) address associated with the apparatus as a basic service set identifier (BSSID) of a basic service set (BSS) corresponding to the main repeater, and
wherein the repeater hosting circuit hosts the one or more virtual repeaters by broadcasting a MAC address associated with the first remote repeater as a BSSID of a BSS corresponding to a first virtual repeater of the one or more virtual repeaters that mimics the first remote repeater.

20. The apparatus of claim 19, wherein:
the processor is capable of hosting the main repeater to service a first station of the one or more stations by performing operations comprising:
servicing the first station by communicating with the first station as the main repeater;
requesting a first remote repeater of the one or more remote repeaters to service the first station; and
ceasing to service the first station upon completion of handoff of the first station to the first remote repeater, and
the processor is capable of hosting a first virtual repeater of the one or more virtual repeaters to service a second station of the one or more stations by performing operations comprising:
receiving a request from a second remote repeater of the one or more remote repeaters to service the second station; and
servicing the second station by communicating with the second station as the first virtual repeater which mimics the second remote repeater responsive to the receiving of the request.
